(19) United States
(12) Patent Application Publication
(10) Pub. No.: US 2026/0186103 A1
(43) Pub. Date: Jul. 2, 2026

(54) DISTANCE MEASURING DEVICE AND MANUFACTURING METHOD

(71) Applicant: SONY SEMICONDUCTOR SOLUTIONS CORPORATION, Kanagawa (JP)

(72) Inventors: Shouji MORINAGA, Kumamoto (JP); Eiichiro DOBASHI, Kanagawa (JP); Hiroki HIYAMA, Kanagawa (JP); Kazuyoshi YAMADA, Tokyo (JP); Shizunori MATSUMOTO, Kanagawa (JP)

(73) Assignee: SONY SEMICONDUCTOR SOLUTIONS CORPORATION, Kanagawa (JP)

(21) Appl. No.: 19/130,315

(22) PCT Filed: Nov. 22, 2023
(86) PCT No.: PCT/JP2023/042049

§ 371 Date: May 15, 2025

(30) Foreign Application Priority Data
Dec. 7, 2022 (JP) 2022-195783

(51) Int. Cl. G01S 7/481; G01S 7/4865; G01S 17/10

(52) U.S. Cl. CPC G01S 7/4815; G01S 7/4813; G01S 7/4816; G01S 7/4865; G01S 17/10

(57) ABSTRACT

To miniaturize a distance measuring device. A distance measuring device includes: a first semiconductor chip that includes light emitting elements; a second semiconductor chip that includes light receiving elements, and first circuitry configured to process pixel signals from the light receiving elements, the second semiconductor substrate being stacked on the first semiconductor substrate; and a third semiconductor chip that includes second circuitry configured to control light emission of the light emitting elements and third circuitry configured to process a signal from the first circuitry, wherein the first semiconductor chip and the second semiconductor chip are individually chip-on-chip connected onto the third semiconductor chip. The present technology is applicable to, for example, a device that measures a distance up to a measurement target.

### TECHNICAL FIELD

The Technology of the present disclosure relates to a distance measuring device and a manufacturing method, for example, to a miniaturized distance measuring device and a manufacturing method of the distance measuring device.

### BACKGROUND ART

In recent years, distance measuring devices that perform distance measurement by using a Time-of-Flight (ToF) method have attracted attention. Some distance measuring devices use a single photon avalanche diode (SPAD) as a light receiving pixel. In a distance measuring device using the SPAD, when one photon enters a PN junction region of a high electric field in a state where a voltage larger than a breakdown voltage is applied, avalanche multiplication occurs. By detecting the timing at which a current instantaneously flows by the avalanche multiplication, the timing at which light reaches can be detected with high accuracy, and the distance can be measured (for example, see PTL 1).

### CITATION LIST

### Patent Literature

PTL 1: JP 2020-134171A

### SUMMARY OF INVENTION

### Technical Problem

Distance measuring devices are installed in various devices. For example, distance measuring devices are also installed in increasingly miniaturized devices such as smartphones. Therefore, miniaturization of the distance measuring device is also desired.

In view of such circumstances, the present technology has been made to achieve the miniaturization of distance measuring devices.

### Solution to Problem

A distance measuring device according to one aspect of the present technology includes: a first semiconductor chip including light emitting elements; a second semiconductor chip including a first semiconductor substrate including light receiving elements, and a second semiconductor substrate including first circuitry (e.g., a transistor 230 and an invertor 234) configured to process pixel signals from the light receiving elements to determine a distance to an object, the second semiconductor substrate being stacked on the first semiconductor substrate; and a third semiconductor chip including second circuitry configured to control light emission of the light emitting elements and third circuitry that processes a signal from the first circuitry, wherein the first semiconductor chip and the second semiconductor chip are individually chip-on-chip connected onto the third semiconductor chip. In embodiments, the third semiconductor chip and the organic substrate may be connected via wire bonding. In embodiments, the third semiconductor chip and the organic substrate may be connected via Flip chip bonding.

A manufacturing method according to one aspect of the present technology includes: individually stacking, by chip-on-chip connection, a first semiconductor chip including light emitting elements and a second semiconductor substrate including light receiving elements on a third semiconductor chip including circuitry configured to control light emission of the light emitting elements; sealing the first to third semiconductor chips with a mold; and forming a conductive coat with a conductive material on the mold.

A distance measuring device according to one aspect of the present technology includes: a first semiconductor chip including light emitting elements; a second semiconductor chip including a first semiconductor substrate including light receiving elements, and a second semiconductor substrate including first circuitry that processes pixel signals from the light receiving elements to determine a distance to an object, the second semiconductor substrate being stacked on the first semiconductor substrate; and a third semiconductor chip including second circuitry that controls light emission of the light emitting elements and third circuitry that processes a signal from the first circuitry, wherein the first semiconductor chip and the second semiconductor chip are individually chip-on-chip connected onto the third semiconductor chip.

In a manufacturing method according to one aspect of the present technology, the distance measuring device is manufactured.

The distance measuring device may be an independent device or may be integrated into another device (e.g., a mobile phone).

### BRIEF DESCRIPTION OF DRAWINGS

FIG. 1 is a diagram illustrating a configuration of a distance measuring device to which the present technology is applied according to one embodiment.

FIG. 2 is a diagram illustrating a configuration of the distance measuring device in a cross-sectional view.

FIG. 3 is a diagram illustrating a configuration of the distance measuring device in a plan view.

FIG. 4 is a diagram illustrating a configuration of a light receiving unit.

FIG. 5 is a diagram illustrating a configuration of the light receiving unit.

FIG. 6 is a diagram illustrating a configuration of a light emitting unit.

FIG. 7 is a diagram illustrating a configuration of the light emitting unit.

FIG. 8 is a diagram illustrating a detailed configuration of the distance measuring device.

FIG. 9 is a diagram illustrating a detailed configuration of the distance measuring device.

FIG. 10 is an explanatory diagram illustrating processing related to manufacture of the distance measuring device.

FIG. 11 is an explanatory diagram illustrating processing related to the manufacture of the distance measuring device.

FIG. 12 is an explanatory diagram illustrating processing related to the manufacture of the distance measuring device.

FIG. 13 is an explanatory diagram illustrating molding of a mold.

### DESCRIPTION OF EMBODIMENTS

Hereinafter, a mode (hereinafter, referred to as an embodiment) for implementing the present technology will be described.

<Configuration of Distance measuring Device>

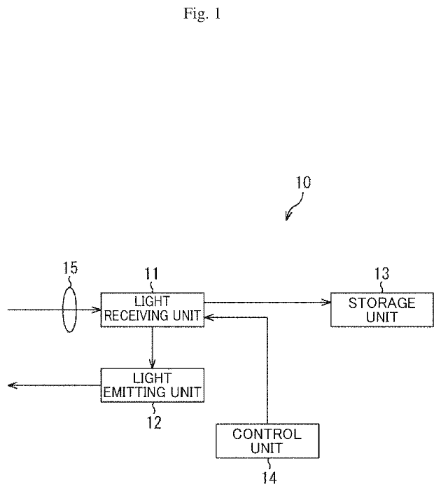

FIG. 1 is a diagram illustrating a configuration of a distance measuring device to which the present technology is applied according to one embodiment. A distance measuring device 10 illustrated in FIG. 1 includes a light receiving unit 11, a light emitting unit 12, a storage unit 13, a control unit 14, and an optical system 15.

The light emitting unit 12 is configured using a laser diode and is driven to emit pulsed laser light, for example. A vertical cavity surface emitting laser (VCSEL) that emits laser light as a surface light source may be used as the light emitting unit 12. Alternatively, an array of laser diodes arranged on a line may be used as the light emitting unit 12, and laser light emitted from the laser diode array may be scanned in a direction perpendicular to the line. A laser diode may also be used as a single light source and laser light emitted from the laser diode may be scanned in horizontal and vertical directions.

The light receiving unit 11 includes a plurality of light receiving elements. For example, the plurality of light receiving elements are arranged in a two-dimensional grid-like formation (matrix) to form a light receiving surface. The optical system 15 guides light incident from the outside to the light receiving surface included in the light receiving unit 11.

The control unit 14 controls the overall operation of the distance measuring device 10. For example, the control unit 14 supplies a light emission trigger, which is a trigger for causing the light emitting unit 12 to emit light, to the light receiving unit 11. The light receiving unit 11 causes the light emitting unit 12 to emit light at the timing based on the light emission trigger and stores time t0, which indicates the light emission timing. The control unit 14 sets a pattern for emitting light to the distance measuring device 10 in response to, for example, an instruction from the outside.

The light receiving unit 11 counts the number of times that the light receiving unit 11 acquires time information (light-receiving time tm) indicating the timing at which light is received on the light receiving surface within a predetermined time range, obtains a frequency for each bin, and generates the above-described histogram. The light receiving unit 11 further calculates a distance D to an object to be measured based on the generated histogram. Information indicating the calculated distance D is stored in the storage unit 13.

### <Cross-Sectional Configuration Example of Distance Measuring Device>

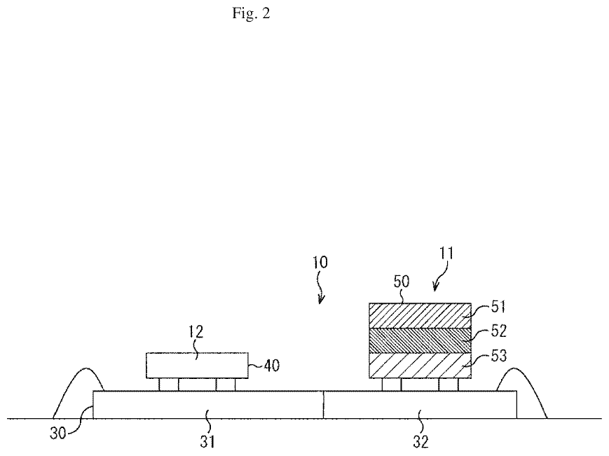

For example, as illustrated in FIG. 2, the distance measuring device 10 has a configuration in which semiconductor substrates are stacked. In the distance measuring device 10, a semiconductor substrate 40 and a semiconductor substrate 50 are stacked on a semiconductor substrate 30.

The semiconductor substrate 30 includes the control unit 14, and a laser diode driver (LDD) 31 and third circuitry 32 are disposed on the semiconductor substrate 30. The LDD 31 controls emission of laser light used for measuring a distance to an object.

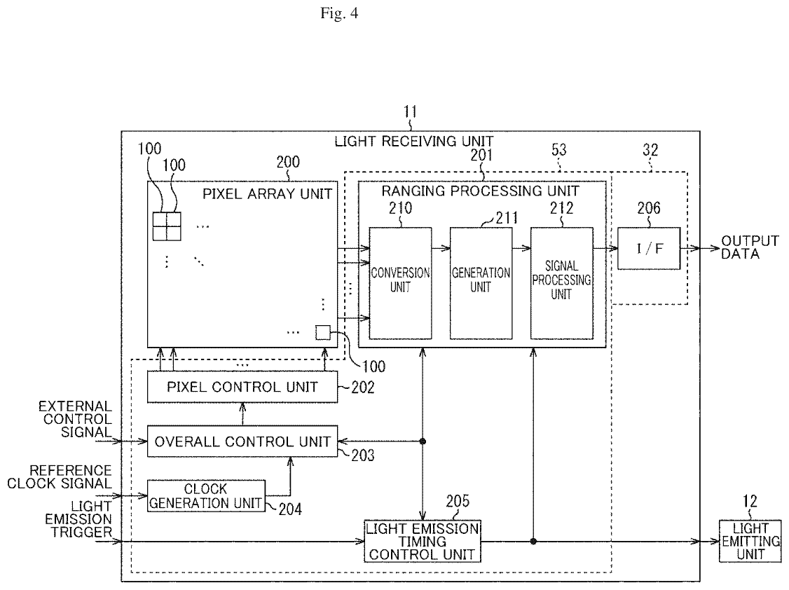

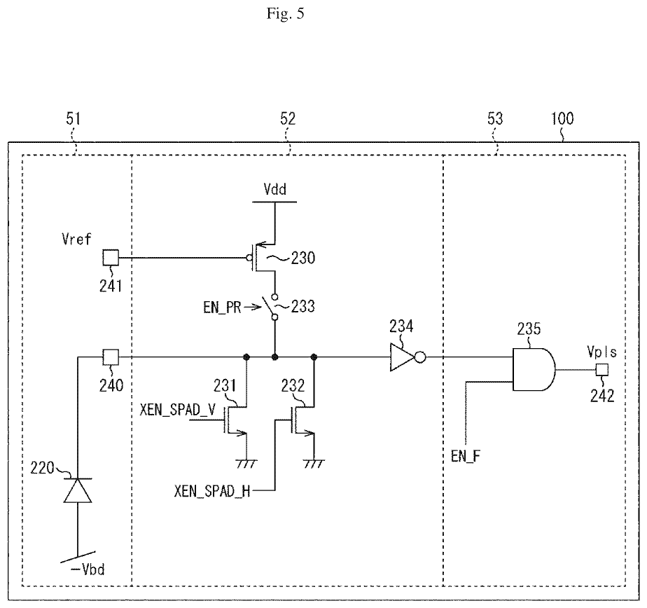

The semiconductor substrate 40 on which the light emitting unit 12 is formed is stacked on the LDD 31 of the semiconductor substrate 30. The semiconductor chip 40 may be disposed to partially overlap the LDD 31 in a plan view. The semiconductor substrate 50 on which the light receiving unit 11 is formed is stacked on the third circuitry 32 of the semiconductor substrate 30. The semiconductor substrate 50 has a configuration including three-stacked substrates of semiconductor substrates 51 to 53. Circuits included in the respective semiconductor substrates 51 to 53 will be described below with reference to FIGS. 4 and 5.

In the present embodiment, the case where the semiconductor substrate 50 is formed of three layers will be further described as an example. However, the semiconductor substrate 50 may be formed of two layers or three or more layers.

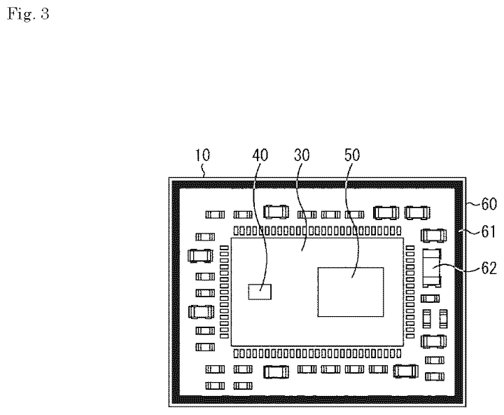

FIG. 3 is a plan view illustrating a configuration example of the distance measuring device 10 having a configuration as in FIG. 2. The semiconductor substrate 30 including the control unit 14 is disposed at a central portion on a substrate 60, which may be an organic substrate or a ceramic substrate. On the semiconductor substrate 30, the semiconductor substrate 40 including the light emitting unit 12 is disposed on the left side in FIG. 2, and the semiconductor substrate 50 including the light receiving unit 11 is disposed on the right side in FIG. 2. Mounted components 62 are arranged around the semiconductor substrate 40 on the substrate 60, and a ground (GND) 61 is formed so as to surround the mounted components 62.

As illustrated in FIGS. 2 and 3, in the distance measuring device 10 to which the present embodiment is applied, the semiconductor substrate 40 including the light emitting unit 12 is stacked on the semiconductor substrate 30 including the control unit 14. In this way, a configuration in which the light emitting unit 12 is stacked on the LDD 31 is formed. Further, a configuration in which the semiconductor substrate 50 including the stacked semiconductor substrates 51 to 53, which constitute the light receiving unit 11, is stacked on the semiconductor substrate 30 is formed. As a result, miniaturization of the distance measuring device 10 can be achieved as illustrated in FIG. 3.

As will be described below, when the distance measuring device 10 has a stacked structure and is covered with an integrally molded mold, the distance measuring device 10 can be miniaturized in a cross-sectional direction (height direction). According to the present technology, the distance measuring device 10 can be miniaturized, and the cost can be reduced.

### <Configuration of Light Receiving Unit>

A configuration example of the light receiving unit 11 will be described with reference to FIGS. 4 and 5.

FIG. 4 is a block diagram illustrating a configuration example of the light receiving unit 11. In FIG. 4, the light receiving unit 11 includes a pixel array unit 200, a distance processing unit 201, a pixel control unit 202, an overall control unit 203, a clock generation unit 204, a light emission timing control unit 205, and an interface (I/F) 206.

Among the pixel array unit 200, the distance processing unit 201, the pixel control unit 202, the overall control unit 203, the clock generation unit 204, the light emission timing control unit 205, and the interface (I/F) 206, the distance processing unit 201, the pixel control unit 202, the overall control unit 203, the clock generation unit 204, and the light emission timing control unit 205 may be provided on the semiconductor substrate 53 (FIG. 2), and the interface (I/F) 206 may be provided in the region of the third circuitry 32 on the semiconductor substrate 30 (FIG. 2).

In FIG. 4, the overall control unit 203 controls the overall operation of the light receiving unit 11 in accordance with, for example, a program installed in advance. The overall control unit 203 can also perform a control operation in accordance with an external control signal supplied from the outside or another device.

The clock generation unit 204 generates at least one clock signal to be used in the light receiving unit 11 based on a reference clock signal supplied from the outside. The light emission timing control unit 205 generates a light emission control signal indicating light emission timing in accordance with a light emission trigger signal supplied from the outside. The light emission control signal is supplied to the light emitting unit 12 and also to the ranging processing unit 201.

The pixel array unit 200 includes a plurality of pixels 100, 100, and . . . , which are arranged in a two-dimensional grid-like formation and each pixel includes a light receiving element. The operation of each pixel 100 is controlled by the pixel control unit 202 in accordance with an instruction from the overall control unit 203. For example, the pixel control unit 202 can control reading of pixel signals from the respective pixels 100 per block including (p×q) pixels 100, that is, p pixels in the row direction and q pixels in the column direction. The pixel control unit 202 can read pixel signals from the respective pixels 100 in the block as a unit by scanning the pixels 100 in the row direction and further scanning the pixels 100 in the column direction.

Alternatively, the pixel control unit 202 can individually control each pixel 100. The pixel control unit 202 can set a predetermined region of the pixel array unit 200 as a target region and set the pixels 100 included in the target region as target pixels 100 from which respective pixel signals are read. The pixel control unit 202 may col-lectively scan a plurality of rows (a plurality of lines) of pixels 100 and further scan the pixels 100 in the column direction so as to read pixel signals from the respective pixels 100.

The pixel signals read from the respective pixels 100 are supplied to the distance processing unit 201. The ranging distance unit 201 includes a conversion unit 210, a generation unit 211, and a signal processing unit 212.

The pixel signals read from the respective pixels 100 and output from the pixel array unit 200 are supplied to the conversion unit 210. The pixel signals are asynchronously read from the respective pixels 100 and supplied to the conversion unit 210. That is, the pixel signal is read from the light receiving element in accordance with the timing at which light is received by each pixel 100 and is output.

The conversion unit 210 converts the pixel signals supplied from the pixel array unit 200 into digital information. That is, the pixel signal supplied from the pixel array unit 200 is output in accordance with the timing at which light is received by the light receiving element included in the pixel 100 corresponding to the pixel signal. The conversion unit 210 converts the supplied pixel signal into time information indicating the light-receiving timing.

The generation unit 211 generates a histogram based on the time information into which the pixel signal has been converted by the conversion unit 210. Specifically, the generation unit 211 generates a histogram by counting the time information based on unit time d set by a setting unit 113.

The signal processing unit 212 performs predetermined arithmetic processing based on the data of the histogram generated by the generation unit 211 to calculate, for example, distance information. The signal processing unit 212 creates a curve approximation of the histogram based on, for example, the data of the histogram generated by the generation unit 211. The signal processing unit 212 can detect a peak of the curve to which the histogram is approximated and obtain a distance D based on the detected peak.

When performing the curve approximation of the histogram, the signal processing unit 212 can perform filter processing on the curve to which the histogram is approximated. For example, the signal processing unit 212 can reduce noise components by performing low-pass filter processing on the curve to which the histogram is approximated.

The distance information obtained by the signal processing unit 212 is supplied to the interface 206. The interface 206 outputs the distance information supplied from the signal processing unit 212 as output data. A mobile industry processor interface (MIPI) can be used as the interface 206.

In the above description, the distance information obtained by the signal processing unit 212 is output via the interface 206. However, the information to be output is not limited to this example. That is, the histogram data, which is the data of the histogram generated by the generation unit 211, may be output via the interface 206. In this case, information indicating a filter coefficient may be omitted from measuring (?) condition information set by the setting unit 113. The histogram data output via the interface 206 is supplied to, for example, an external information processing apparatus and appro-priately processed.

FIG. 5 is a diagram illustrating a basic configuration example of the pixel 100. In FIG. 5, the pixel 100 includes a light receiving element 220, transistors 230 to 232, a switch portion 233, an inverter 234, and an AND circuit 235.

Among the light receiving element 220, the transistors 230 to 232, the switch portion 233, the inverter 234, and the AND circuit 235, the light receiving element 220 is provided on the semiconductor substrate 51, the transistors 230 to 232, the switch portion 233, and the inverter 234 are provided on the semiconductor substrate 52, and the AND circuit 235 is provided on the semiconductor substrate 53.

The light receiving element 220 converts incident light into an electric signal by photoelectric conversion and outputs the converted electric signal. The light receiving element 220 converts an incident photon into an electric signal by photoelectric conversion and outputs a pulse corresponding to the incident photon. The following description will be made using, as an example, a case in which a single photon avalanche diode is used as the light receiving element 220.

Hereinafter, a single photon avalanche diode will be referred to as a single photon avalanche diode (SPAD). The SPAD has characteristics in which when a large negative voltage at which avalanche multiplication occurs is applied to a cathode, electrons generated in response to incidence of one photon cause avalanche multiplication to occur and a large current flows. By using these characteristics of the SPAD, the incidence of one photon can be detected with high sensitivity.

In FIG. 5, the light receiving element 220, which is a SPAD, has a cathode connected to a coupling portion 240 and an anode connected to a voltage source at a voltage (−Vbd). The voltage (−Vbd) is a large negative voltage for the SPAD to cause avalanche multiplication to occur.

The coupling portion 240 is connected to one end of the switch portion 233, which is controlled to be ON (closed) or OFF (open) in accordance with a signal EN_PR. The other end of the switch portion 233 is connected to the drain of the transistor 230, which is a P-channel metal oxide semiconductor field effect transistor (MOSFET). The source of the transistor 230 is connected to a power supply voltage Vdd. The gate of the transistor 230 is connected to a coupling portion 241 to which a reference voltage Vref is supplied.

The transistor 230 is a current source that outputs a current corresponding to the power supply voltage Vdd and the reference voltage Vref from the drain. With this configuration, a reverse bias is applied to the light receiving element 220. When the switch portion 233 is in the ON state and a photon is incident on the light receiving element 220, avalanche multiplication is started, and a current flows from the cathode to the anode of the light receiving element 220.

A signal extracted from a connection point between the drain of the transistor 230 (one end of the switch portion 233) and the cathode of the light receiving element 220 is input to the inverter 234. The inverter 234 performs, for example, threshold deter-mination on the input signal. Each time the input signal exceeds a threshold in a positive direction or a negative direction, the inverter 234 inverts the signal and outputs the inverted signal as a pulsed signal Vpls.

The signal Vpls output from the inverter 234 is input to a first input terminal of the AND circuit 235. A signal EN_F is input to a second input terminal of the AND circuit 235. When both the signal Vpls and the signal EN_F are in a high state, the AND circuit 235 outputs the signal Vpls from the pixel 100 via a terminal 242.

In FIG. 5, the drains of the transistors 231 and 232, each of which is an N-channel MOSFET, are further connected to the coupling portion 240. The sources of the transistors 231 and 232 are connected to, for example, the ground potentials. A signal XEN_SPAD_V is input to the gate of the transistor 231. A signal XEN_SPAD_H is input to the gate of the transistor 232. When at least one of the transistors 231 and 232 is in the OFF state, the cathode of the light receiving element 220 is forcibly set to the ground potential, and the signal Vpls is fixed to the low state.

The signals XEN_SPAD_V and XEN_SPAD_H are used as control signals in the vertical direction and the horizontal direction, respectively, of the two-dimensional grid on which the pixels 100 are arranged in the pixel array unit 200. This makes it possible to individually control the ON state/OFF state of each pixel 100 included in the pixel array unit 200. When the pixel 100 is in the ON state, the signal Vpls can be output, and when the pixel 100 is in the OFF state, the signal Vpls cannot be output.

For example, in the pixel array unit 200, the signal XEN_SPAD_H is set to a state that turns on the transistor 232 for q consecutive columns of the two-dimensional grid, and the signal XEN_SPAD_V is set to a state that turns on the transistor 231 for p consecutive rows of the two-dimensional grid. As a result, the output of the corresponding ones of the light receiving elements 220 in a block form of p rows×q columns can be enabled. In addition, since the signal Vpls is output from the pixel 100 through the AND circuit 235 based on the logical AND of the signal Vpls and the signal EN_F, whether to enable/disable the output of each light receiving element 220 that has been enabled by, for example, the signals XEN_SPAD_V and XEN_SPAD_H can be more finely controlled.

Further, for example, the signal EN_PR, which sets the switch portion 233 to be in the OFF state, is supplied to the pixel 100 that includes the light receiving element 220 whose output is disabled so that the supply of the power supply voltage Vdd to the light receiving element 220, thereby setting the corresponding pixel 100 to be in the OFF state. As a result, power consumption in the pixel array unit 200 can be reduced.

These signals XEN_SPAD_V, XEN_SPAD_H, EN_PR, and EN_F are generated by the overall control unit 203 based on, for example, parameters stored in a register or the like included in the overall control unit 203. The parameters may be stored in the register in advance or may be stored in the register in accordance with an external input. The signals XEN_SPAD_V, XEN_SPAD_H, EN_PR, and EN_F generated by the overall control unit 203 are supplied to the pixel array unit 200 by the pixel control unit 202.

The above-described control operations by the signals XEN_SPAD_V, XEN_SPAD_H, and EN_PR using the switch portion 233 and the transistors 231 and 232 are performed with an analog voltage, whereas the control operation by the signal EN_F using the AND circuit 235 is performed with a logic voltage. Thus, the control operation by the signal EN_F can be performed at a lower voltage than the control operations by the signals XEN_SPAD_V, XEN_SPAD_H, and EN_PR and is easy to handle.

### <Configuration of Light Emitting Unit>

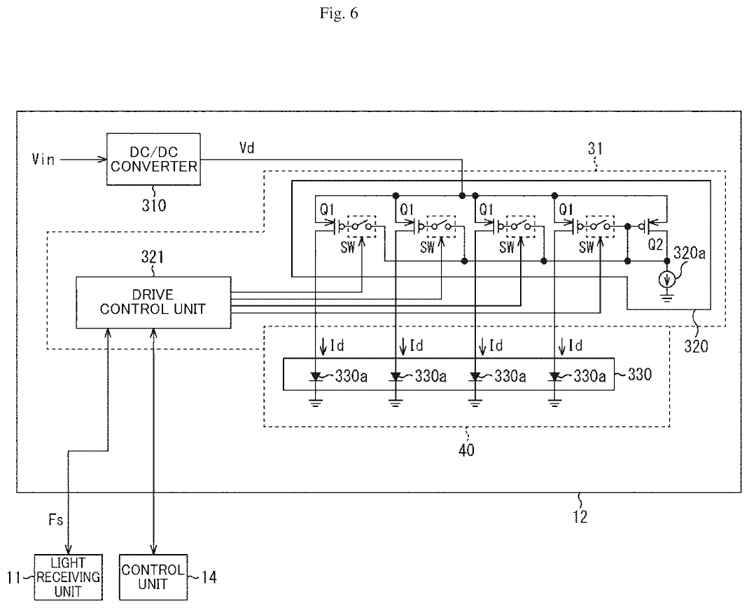

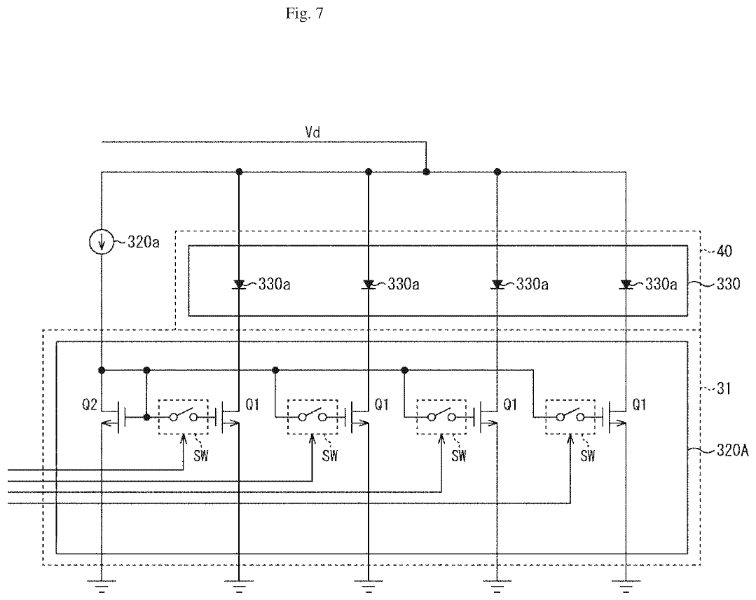

Configuration examples of the light emitting unit 12 will be described with reference to FIGS. 6 and 7.

FIG. 6 illustrates a circuit configuration example of the light emitting unit 12 including a light emitting element unit 330 and a drive unit 320. FIG. 6 also illustrates the light receiving unit 11 and the control unit 14 illustrated in FIG. 1, together with the circuit configuration example of the light emitting unit 12.

The light emitting unit 12 includes a DC/DC converter 310, the drive unit 320, and the light emitting element unit 330. The light emitting element unit 330 includes a plurality of light emitting elements 330a as VCSELs as described above. Although the number of light emitting elements 330a is “4” in FIG. 6 for convenience of illustration, the number of the light emitting elements 330a in the light emitting element unit 330 is not limited to this example and may be at least two or more.

The light emitting unit 12 includes the DC/DC converter 310 and generates a driving voltage Vd (DC voltage) used by the drive unit 320 for driving the light emitting element unit 330 based on an input voltage Vin, which is a DC voltage.

The drive unit 320 includes a drive control unit 321. The drive unit 320 includes a switching element Q1 and a switch SW for each light emitting element 330a and also includes a switching element Q2 and a constant current source 320a. Field-effect transistors (FETs) are used for the switching elements Q1 and the switching element Q2. In the present example, P-channel MOSFETs are used.

The switching elements Q1 are connected in parallel with respect to an output line of the DC/DC converter 310, that is, a supply line of the driving voltage Vd, and the switching element Q2 is connected in parallel with the switching elements Q1. Specifically, the sources of each switching element Q1 and the switching element Q2 are connected to the output line of the DC/DC converter 310. The drain of each switching element Q1 is connected to the anode of a corresponding one of the light emitting elements 330a in the light emitting element unit 330. As illustrated in FIG. 6, the cathode of each light emitting element 330a is connected to the ground (GND).

The drain of the switching element Q2 is connected to the ground via the constant current source 320a, and the gate of the switching element Q2 is connected to a connection point between the drain and the constant current source 320a. The gate of each switching element Q1 is connected to the gate of the switching element Q2 via a corresponding one of the switches SW.

In the drive unit 320 according to the above configuration, when the switch SW corresponding to the switching element Q1 is turned ON, a current flows through the switching element Q1. Thus, a driving voltage Vd is applied to the light emitting element 330a connected to this electrically connected switching element Q1 so that the light emitting element 330a emits light.

At this point, a driving current Id flows through the light emitting element 330a. In the drive unit 320 according to the above-described configuration, the switching elements Q1 and the switching element Q2 constitute a current mirror circuit, and the current value of the driving current Id is set to a value corresponding to the current value of the constant current source 320a.

The drive control unit 321 controls ON/OFF of the light emitting element 330a by performing the ON/OFF control operation on the corresponding switch SW in the drive unit 320. Based on instructions from the control unit 14, the drive control unit 321 determines the timing of the ON/OFF control operation performed on the light emitting element 330a, a laser power level (current value of the driving current Id), etc.

For example, the drive control unit 321 receives, as light emission parameters, values that specify these instructions from the control unit 14 and performs the drive control operation on the light emitting element 330a in accordance with the received values. A frame synchronization signal Fs is supplied to the drive control unit 321 from the light receiving unit 11. This allows the drive control unit 321 to synchronize the ON timing and the OFF timing of the light emitting element 330a with a frame cycle of the light receiving unit 11.

Alternatively, the drive control unit 321 may be configured to transmit signals indicating the frame synchronization signal Fs and exposure timing to the light receiving unit 11. Further, the control unit 14 may be configured to transmit signals indicating the frame synchronization signal Fs and light-emitting and exposure timing to the drive control unit 321 and the light receiving unit 11.

While FIG. 6 illustrates an example of the configuration in which the switching elements Q1 are provided on the anode side of the light emitting elements 330a, the switching elements Q1 may be provided on the cathode side of the light emitting elements 330a as with a drive unit 320A illustrated in FIG. 7. In this case, the anode of each light emitting element 330a in the light emitting element unit 330 is connected to the output line of the DC/DC converter 310.

N-channel MOSFETs are used for the switching elements Q1 and the switching element Q2 that constitute the current mirror circuit. The drain and the gate of the switching element Q2 are connected to the output line of the DC/DC converter 310 via the constant current source 320a, and the source of the switching element Q2 is connected to the ground via the constant current source 320a. The drain of each switching element Q1 is connected to the cathode of the corresponding light emitting element 330a, and the source of each switching element Q1 is connected to the ground. The gate of each switching element Q1 is connected to the gate and the drain of the switching element Q2 via the corresponding switch SW.

In this case, too, the drive control unit 321 controls ON/OFF of the light emitting element 330a by performing the ON/OFF control operation on the corresponding switch SW.

In the light emitting unit 12 illustrated in FIGS. 6 and 7, the drive unit 320 and the drive control unit 321 that constitute the light emitting unit 12 may be included in the LDD 31 of the semiconductor substrate 30 (FIG. 2). The light emitting element unit 330 that constitutes the light emitting unit 12 may be included in the semiconductor substrate 40 (FIG. 2). The DC/DC converter 310 may also be included in the LDD 31.

### <Detailed Configuration of Distance Measuring Device>

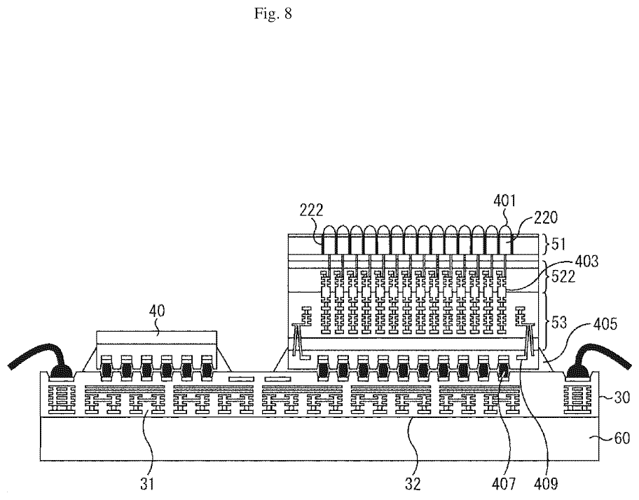

A detailed configuration of the distance measuring device 10 illustrated in FIG. 2 will be described with reference to FIG. 8. The semiconductor substrate 30 is disposed on the substrate 60. The LDD 31 and the third circuitry 32 are formed on the semiconductor substrate 30.

The semiconductor substrate 40 on which the light emitting element unit 330 is disposed is disposed on the left side of the semiconductor substrate 30 in FIG. 8. The semiconductor substrate 30 and the semiconductor substrate 40 are electrically connected to each other by bumps 407.

The semiconductor substrate 30 and the semiconductor substrate 40 are connected by, for example, an under bump metal (UBM) process. The UBM process includes a step for coating, on a wafer, the metal that serves as bases for bump formation and the barrier metal of exposed pads, which is a process performed prior to a process in which bumps are formed with solder or Au (gold) to prepare for connecting the semiconductor substrate 30 and the semiconductor substrate 40 and heat and pressure are applied so that the semiconductor substrate 30 and the semiconductor substrate 40 are connected to each other and brought into conduction.

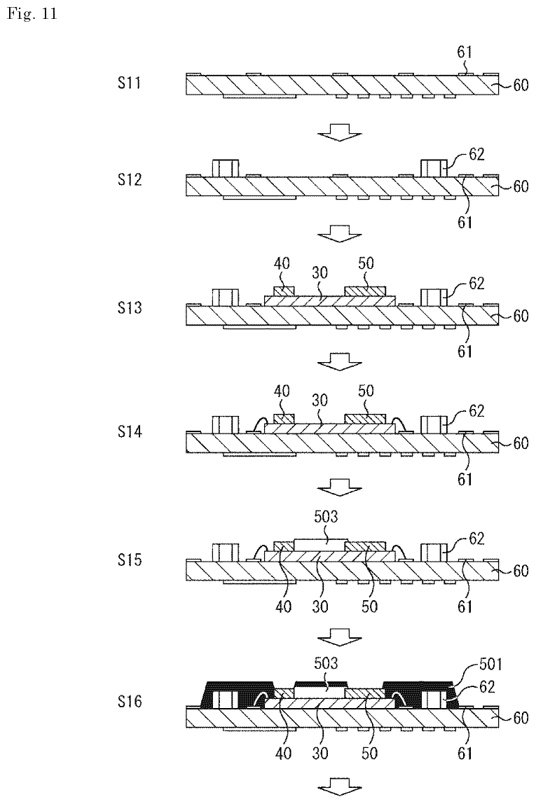

As will be described below with reference to FIG. 11, there is a process in which a semiconductor substrate 40, which is obtained by dicing from a wafer, is disposed on each of a plurality of semiconductor substrates 30 formed on a wafer. Prior to this process, the UBM process is performed so as to coat each of the metal that serves as bases for bump formation and the barrier metal of exposed pads.

Similarly, the semiconductor substrate 50 is disposed on the semiconductor substrate 30, and the semiconductor substrate 30 and the semiconductor substrate 50 are electrically connected to each other by bumps 407. This connection process is performed after the UBM process.

The semiconductor substrate 50 has a configuration in which the semiconductor substrates 51 to 53 are stacked. The semiconductor substrate 51 is a substrate located on a light incident surface side, and the light receiving elements 220 are formed thereon. SPADs may be used as the light receiving elements 220. The light receiving elements 220 are separated from each other by inter-pixel separation portions 222. An on-chip lens 401 is disposed on each light receiving element 220.

The semiconductor substrate 52 is stacked on the lower side of the semiconductor substrate 51 in FIG. 8. As described with reference to FIG. 5, the transistors 231 and 232, the inverter 234, and the like are formed on the semiconductor substrate 52.

The semiconductor substrate 53 is stacked on the lower side of the semiconductor substrate 52 in FIG. 8. As described with reference to FIGS. 4 and 5, logic circuits such as the distance processing unit 201, the pixel control unit 202, the overall control unit 203, the clock generation unit 204, and the light emission timing control unit 205 are formed on the semiconductor substrate 53. A through silicon via (TSV) 409 is formed on the semiconductor substrate 53 and connected to a re-distribution layer (RDL) in the horizontal direction.

The semiconductor substrate 52 and the semiconductor substrate 53 are electrically connected to each other by Cu—Cu connection (bumps 407) in a connection unit 403.

The space between the semiconductor substrate 30 and the semiconductor substrate 40 is filled with an underfill 405 for sealing and protecting electrodes electrically connecting the semiconductor substrate 30 and the semiconductor substrate 40. The space between the semiconductor substrate 30 and the semiconductor substrate 50 is filled with an underfill 405 for sealing and protecting electrodes electrically connecting the semiconductor substrate 30 and the semiconductor substrate 50.

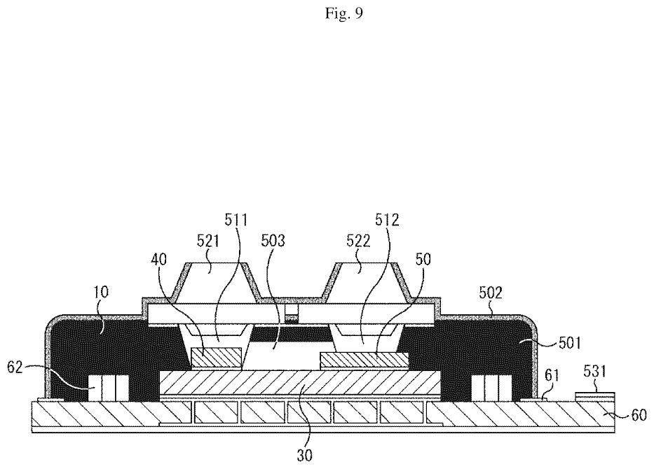

As illustrated in FIG. 9, the distance measuring device 10 having the above configuration is covered with an integrally molded mold. In FIG. 9, the distance measuring device 10 illustrated in FIG. 8 is partially simplified and illustrated. The distance measuring device 10 described with reference to FIG. 8, etc. is sealed by a mold 501. In this way, the mounted components 62 disposed on the substrate 60 and the semiconductor substrates 30, 40, and 50 can be protected from being affected by impact, temperature, humidity, or the like.

A side surface on the left side of the semiconductor substrate 40 in FIG. 9 will be referred to as a first side surface, and a side surface on the right side (a surface opposite to the first side surface) will be referred to as a second side surface. A side surface (a surface facing the second side surface) on the left side of the semiconductor substrate 50 in FIG. 9 will be referred to as a third side surface, and a side surface on the right side (a surface opposite to the third side surface) will be referred to as a fourth side surface. A side surface on the left side of the semiconductor substrate 30 in FIG. 9 will be referred to as a fifth side surface, and a side surface on the right side (a surface opposite to the fifth side surface) will be referred to as a sixth side surface. When the side surfaces are defined as described above, the distance measuring device 10 illustrated in FIG. 9 has a configuration in which the first side surface, the fourth side surface, the fifth side surface, and the sixth side surface are covered by the mold 501 (mold resin).

A transparent body 503 is disposed between the semiconductor substrate 40 and the semiconductor substrate 50, in other words, between the second side surface and the third side surface. The transparent body 503 is formed of resin or glass.

An opening portion 511 and an opening portion 512 of the mold 501 are formed on a light emitting surface side of the semiconductor substrate 30 including the light emitting unit 12 and a light receiving surface side of the semiconductor substrate 50 including the light receiving unit 11, respectively. A lens 521 for diffusing light emitted by the light emitting unit 12 is disposed in the opening portion 511, and a lens 522 for condensing light incident on the light receiving unit 11 is disposed in the opening portion 512.

A conductive coat 502 is formed on the side surfaces of the lenses 521 and 522 and portions other than the opening portions 511 and 512 of the mold 501. The conductive coat 502 is provided to block electromagnetic waves. The conductive coat 502 may be a film having an antireflection function. For example, the conductive coat 502 has a function of shielding electromagnetic waves and is formed by using a black material. Alternatively, a black material may be applied over the conductive coat 502.

The conductive coat 502 is formed in contact with the GND 61 formed on the substrate 60. The conductive coat 502 and the GND 61 are electrically connected to each other. The GND 61 serves as a metal terminal connected to the conductive coat 502.

According to the present technology, as illustrated in FIG. 9, with the configuration in which the conductive coat 502 and the GND 61 formed on the substrate 60 are connected to each other, a structure without, for example, a shield can, a housing, or the like that may serve as a substitute for the conductive coat 502 can be achieved, and thus, the cost can be reduced. The conductive coat 502 can be formed by spraying a conductive material. Since the conductive coat 502 can be formed by such processing, a soldering step can be eliminated, and the conductive coat 502 and the GND 61 can be reliably connected to each other without failing to accurately apply the conductive coat 502 onto the GND 61. Therefore, there is no need to secure an extra space so that miniaturization of the distance measuring device 10 can be achieved.

### <Manufacture of Distance Measuring Device>

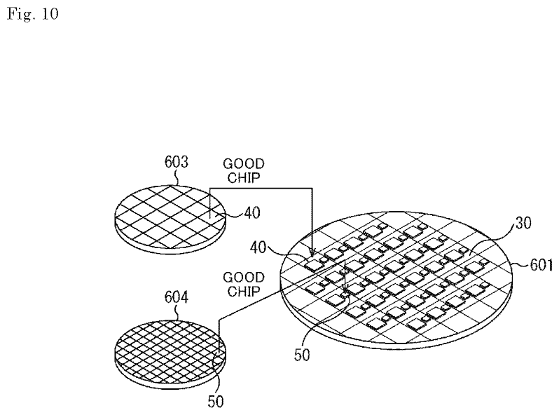

A Chip on Wafer (CoW) technique can be applied to the manufacturing process of the distance measuring device 10 described above. FIG. 10 is an explanatory diagram illustrating the CoW technique applicable when manufacturing the distance measuring device 10.

The semiconductor substrates 40 and the semiconductor substrates 50, which have been diced and confirmed to be good chips, are stacked on a wafer 601 corresponding to the semiconductor substrates 30 on each of which the LDD 31 and the third circuitry 32 are formed. The individual semiconductor substrate 50 is in a state where the semiconductor substrates 51 to 53 have been stacked.

The wafer 601 is a plurality of semiconductor substrates 30 on each of which the LDD 31 and the third circuitry 32 are formed by semiconductor processing. On the semiconductor substrates 30 formed on the wafer 601, the semiconductor substrates 40, which have been formed on a wafer 603 by semiconductor processing, diced into individual pieces, and then each inspected electrically and confirmed to be a good chip, and the semiconductor substrates 50, which have been formed on a wafer 604, diced into individual pieces, and then each inspected electrically and confirmed to be a good chip, are selected and rearranged. By performing this CoW process, the semiconductor substrate 40 and the semiconductor substrate 50 are stacked on the semiconductor substrate 30.

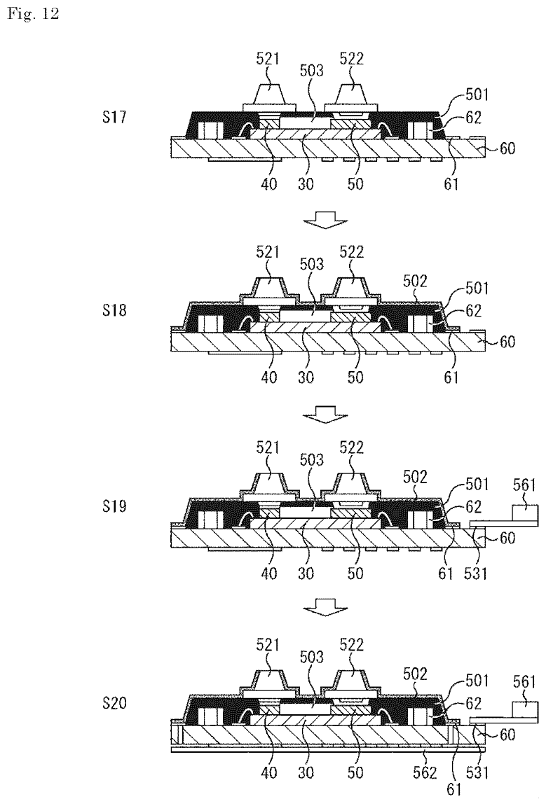

The manufacture of the distance measuring device 10 will be further described with reference to FIGS. 11 and 12. In step S11, the substrate 60 is prepared. In step S12, the mounted components 62 are mounted on the substrate 60. The mounted components 62 are mounted on the substrate 60 by, for example, soldering.

In step S13, the semiconductor substrate 30 on which the semiconductor substrate 40 and the semiconductor substrate 50, which have been manufactured as described above with reference to FIG. 10, are stacked is mounted on the substrate 60. The substrate 60 and the semiconductor substrate 30 are bonded to each other using, for example, an adhesive. In step S14, the substrate 60 and the semiconductor substrate 30 are electrically connected to each other by wiring. For example, an Au (gold) wire can be used as the wiring.

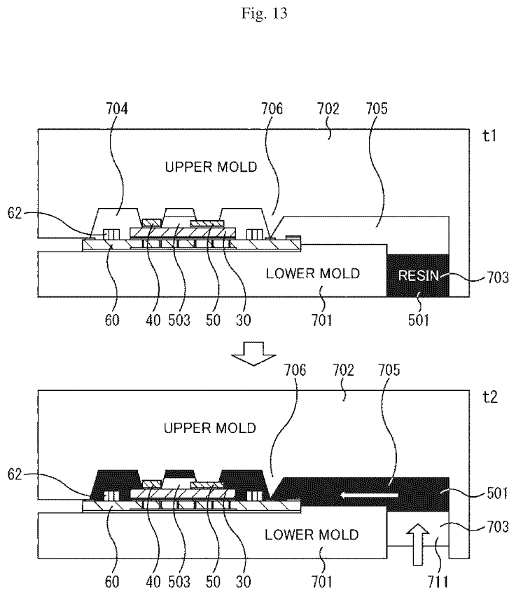

In step S15, the transparent body 503 is mounted between the semiconductor substrate 40 and the semiconductor substrate 50. In step S16, the mold 501 is formed. Formation of the mold 501 will be described with reference to FIG. 13.

The distance measuring device 10 manufactured in the steps up to step S15 is disposed between a lower mold 701 and an upper mold 702 and on the lower mold 701. The upper mold 702 is a metal mold in which a cavity 704 is provided in a region where the mold 501 is to be formed. A pod 703 into which a tablet-type resin 501, which is a material of the mold 501, is injected is provided on the right side of the lower mold 701 in FIG. 13. A runner 705 through which the resin 501 runs and a gate 706 are provided in the upper mold 702.

At time t1, after the distance measuring device 10 is disposed on the lower mold 701, the lower mold 701 and the upper mold 702 are pressed to be clamped. The tablet-type resin 501 is injected into the pod 703, and the lower mold 701 and the upper mold 702 are heated to a high temperature, for example, 170 degrees. A thermosetting resin can be used as the resin 501.

At time t2, by raising plungers 711, the resin 501 in the pod 703 passes through the runner 705 and the gate 706 and fills the cavity 704.

The mold 501 is thus integrally molded.

Note that the molding method using the thermosetting resin described with reference to FIG. 13 is an example, and other molding methods may be used. For example, a method such as compression molding using a liquid thermosetting resin or injection molding using a thermoplastic resin may be used.

Once the mold 501 has been integrally molded, in step S17 (FIG. 12), the lens 521 and the lens 522 are installed in the opening portion 511 and the opening portion 512, respectively. For example, the lens 521 and the lens 522 are fixed by applying an adhesive to the installation regions provided in the mold 501.

In step S18, the conductive coat 502 is formed. The conductive coat 502 is formed on the mold 501 and the like by, for example, spraying a conductive material in a state where the surface of the lens 521 from which light is emitted and the surface of the lens 522 on which light is incident are masked. In this step, a conductive material to be the conductive coat 502 is also sprayed onto the GND 61 formed on the substrate 60 so that the conductive coat 502 and the GND 61 are also connected to each other.

The distance measuring device 10 illustrated in FIG. 9 is manufactured by performing the steps up to step S18. Further, in step S19, a flexible substrate 561 is connected to a terminal 531 of the distance measuring device 10. The flexible substrate 561 is, for example, a substrate on which a processing circuit for processing signals from the distance measuring device 10 is formed.

In step S20, a metal plate 562 is connected to the lower surface of the substrate 60 (the surface opposite to the side on which the semiconductor substrate 30 and the like are disposed) by using, for example, an adhesive. The metal plate 562 is used as a re-inforcing material.

In this way, (a module including) the distance measuring device 10 is manufactured.

According to the present technology, the size and weight of the distance measuring device 10 can be reduced. The number of components can be reduced, and the number of manufacturing steps can be reduced. As a result, the cost can be reduced.

In the present specification, a system refers to the whole device including a plurality of devices.

The advantageous effects described in the present specification are merely examples and are not necessarily limited, and there may be other advantageous effects.

Embodiments of the present technology are not limited to the above-described embodiments, and various modifications can be made without departing from the scope of the present technology.

The present technology can also be configured as follows.

(1)

A distance measuring device including:
a first semiconductor chip that includes light emitting elements;
a second semiconductor chip that includes a first semiconductor substrate that includes light receiving elements, and a second semiconductor substrate that includes the first circuitry that generates distance information up to a measurement target by using information from the light receiving elements, the second semiconductor substrate being stacked on the first semiconductor substrate; and
a third semiconductor chip that includes at least second circuitry that controls light emission of the light emitting elements and third circuitry that processes a signal from the first circuitry,
wherein the first semiconductor chip and the second semiconductor chip are individually chip-on-chip connected onto the third semiconductor chip.
   (2)

The distance measuring device according to claim 1, wherein the first semiconductor chip and the second semiconductor chip are individually chip-on-chip connected onto the third semiconductor chip.

(3)

The distance measuring device according to (1), wherein the light receiving elements are single photon avalanche diodes (SPADs).

(4)

The distance measuring device according to (1) or (2), wherein the light emitting elements are vertical cavity surface emitting LASERS (VCSELs).

(5)

The distance measuring device according to any one of (1) to (3), wherein the first semiconductor chip is disposed so as to overlap the second circuitry in a plan view.

(6)

The distance measuring device according to any one of (1) to (4),
wherein the first semiconductor chip has a first side surface and a second side surface, which is a side surface opposite to the first side surface,
wherein the second semiconductor chip has a third side surface, which faces the second side surface, and a fourth side surface, which is a side surface opposite to the third side surface,
wherein the third semiconductor chip has a fifth side surface and a sixth side surface, which is a side surface opposite to the fifth side surface, and
wherein the first side surface, the fourth side surface, the fifth side surface, and the sixth side surface are covered by a mold resin.
   (7)

The distance measuring device according to any one of (1) to (5), wherein the first to third semiconductor chips are sealed with a mold resin.

(8)

The distance measuring device according to (5) or (6), further including a conductive coat that covers the mold resin and is formed of a conductive material.

(9)

The distance measuring device according to (7), further including an organic substrate that has the third semiconductor chip stacked thereon,
wherein the organic substrate includes a metal terminal that is formed on a surface on the third semiconductor chip side, and
the conductive coat is connected to the metal terminal.
   (10)

The distance measuring device according to (9), wherein the metal terminal is GND.

(11)

The distance measuring device according to (10), wherein the conductive coat is black.

(12)

The distance measuring device according to (11), wherein an edge of the organic substrate is located outside an edge of the conductive coat in a plan view.

(13)

The distance measuring device according to claim 1, wherein the first circuitry includes a transistor and an invertor.

(14)

The distance measuring device according to claim 1, further comprising: a bump connection between the first semiconductor chip and the third semiconductor chip, and between the second semiconductor chip and the third semiconductor chip.

(15)

The distance measuring device according to (9), wherein a metal plate is stacked on a lower surface of the organic substrate.

(16)

The distance measuring device according to claim 7, further comprising: a lens module including a first lens and a second lens disposed above the mold resin.

(17)

The distance measuring device according to claim 16, wherein the conductive coat covers side surfaces of the lens module.

(18)

The distance measuring device according to (9), wherein the third semiconductor chip and the organic substrate are connected via wire bonding.

(19)

The distance measuring device according to (9), wherein the third semiconductor chip (30) and the organic substrate are connected via Flip chip bonding.

(20)

A manufacturing method including:
individually stacking, by chip-on-chip connection, a first semiconductor chip that includes light emitting elements and a second semiconductor substrate that includes light receiving elements on a third semiconductor chip;
sealing the first to third semiconductor chips with a mold; and
forming a conductive coat with a conductive material on the mold,
wherein the second semiconductor substrate includes first circuitry configured to process pixel signals from the light receiving elements, and
wherein the third semiconductor chip includes second circuitry configured to control light emission of the light emitting elements and third circuitry configured to process a signal from the first circuitry.

### REFERENCE SIGNS LIST

10 Distance measuring device
11 Light receiving unit
12 Light emitting unit
13 Storage unit
14 Control unit
15 Optical system
30 Semiconductor substrate
31 second circuitry/LDD
32 Peripheral circuit/third circuitry
40 Semiconductor substrate
50, 51, 52, 53 Semiconductor substrate
60 Substrate
61 GND
62 Mounted component
100 Pixel
113 Setting unit
200 Pixel array unit
201 Ranging processing unit
202 Pixel control unit
203 Overall control unit
204 Clock generation unit
205 Light emission timing control unit
206 Interface
210 Conversion unit
211 Generation unit
212 Signal processing unit
220 Light receiving element
222 Inter-pixel separation portion
230 Transistor
231 Transistor
232 Transistor
233 Switch portion
234 Inverter
235 AND circuit
240 Coupling portion
241 Coupling portion
242 Terminal
310 DC/DC converter
320 Drive unit
321 Drive control unit
330 Light emitting element
401 On-chip lens
403 Connection portion
405 Underfill
407 Bump
501 Mold
502 Conductive coat
503 Transparent body
511, 512 Opening portion
521, 522 Lens
531 Terminal
551 Shield can
552 Solder
561 Flexible substrate
562 Metal plate
601 Wafer
603 Wafer
604 Wafer
701 Lower mold
702 Upper mold
703 Pod
704 Cavity
705 Runner
706 Gate
711 Plunger

What is claimed is:

1. A distance measuring device, comprising:
a first semiconductor chip including light emitting elements;
a second semiconductor chip including:
a first semiconductor substrate including light receiving elements; and
a second semiconductor substrate including first circuitry configured to process pixel signals from the light receiving elements, wherein the second semiconductor substrate is stacked on the first semiconductor substrate; and
a third semiconductor chip including:
second circuitry configured to control light emission of the light emitting elements; and
third circuitry configured to process a signal from the first circuitry.

2. The distance measuring device according to claim 1, wherein the first semiconductor chip and the second semiconductor chip are individually chip-on-chip connected onto the third semiconductor chip.

3. The distance measuring device according to claim 1, wherein the light receiving elements are single photon avalanche diodes (SPADs).

4. The distance measuring device according to claim 1, wherein the light emitting elements are vertical cavity surface emitting LASERS (VCSELs).

5. The distance measuring device according to claim 1, wherein the first semiconductor chip is disposed to partially overlap the second circuitry in a plan view.

6. The distance measuring device according to claim 1,
wherein the first semiconductor chip has a first side surface and a second side surface, which is a side surface opposite to the first side surface,
wherein the second semiconductor chip has a third side surface, which faces the second side surface, and a fourth side surface, which is a side surface opposite to the third side surface,
wherein the third semiconductor chip has a fifth side surface and a sixth side surface, which is a side surface opposite to the fifth side surface, and
wherein the first side surface, the fourth side surface, the fifth side surface, and the sixth side surface are covered by a mold resin.

7. The distance measuring device according to claim 1, wherein the first semiconductor chip, the second semiconductor chip, and the third semiconductor chips are sealed with a mold resin.

8. The distance measuring device according to claim 7, further comprising a conductive coat that covers the mold resin and is formed of a conductive material.

9. The distance measuring device according to claim 8, further comprising:
an organic substrate that has the third semiconductor chip stacked thereon,
wherein the organic substrate includes a metal terminal that is formed on a surface on the third semiconductor chip side, and
the conductive coat is connected to the metal terminal.

10. The distance measuring device according to claim 9, wherein the metal terminal is connected to GND.

11. The distance measuring device according to claim 10, wherein the conductive coat is black.

12. The distance measuring device according to claim 11, wherein an edge of the organic substrate is located outside an edge of the conductive coat in a plan view.

13. The distance measuring device according to claim 1, wherein the first circuitry includes a transistor and an invertor.

14. The distance measuring device according to claim 1, further comprising:
a first bump connection between the first semiconductor chip and the third semiconductor chip, and a second bump connection between the second semiconductor chip and the third semiconductor chip.

15. The distance measuring device according to claim 9, wherein a metal plate stacked on a lower surface of the organic substrate.

16. The distance measuring device according to claim 7, further comprising:
a lens module including a first lens and a second lens disposed above the mold resin.

17. The distance measuring device according to claim 16, wherein the conductive coat covers side surfaces of the lens module.

18. The distance measuring device according to claim 1, wherein the third semiconductor chip and the organic substrate are connected via wire bonding.

19. The distance measuring device according to claim 1, wherein the third semiconductor chip and the organic substrate are connected via Flip chip bonding.

20. A manufacturing method, comprising:
individually stacking, by chip-on-chip connection, a first semiconductor chip that includes light emitting elements and a second semiconductor substrate that includes light receiving elements on a third semiconductor chip;
sealing the first to third semiconductor chips with a mold; and
forming a conductive coat with a conductive material on the mold,
wherein the second semiconductor substrate includes first circuitry configured to process pixel signals from the light receiving elements, and
wherein the third semiconductor chip includes second circuitry configured to control light emission of the light emitting elements and third circuitry configured to process a signal from the first circuitry.
